(19) United States
(12) Patent Application Publication
(10) Pub. No.: US 2014/0118482 A1
(43) Pub. Date: May 1, 2014

(54) METHOD AND APPARATUS FOR 2D TO 3D CONVERSION USING PANORAMA IMAGE

(71) Applicant: KOREA ADVANCED INSTITUTE OF SCIENCE AND TECHNOLOGY, Daejeon (KR)

(72) Inventors: Jun Yong Noh, Daejeon (KR); Sung Woo Choi, Daejeon (KR); Roger Blanco Ribera, Daejeon (KR); Young Hui Kim, Gyeonggi-do (KR); Jung Jin Lee, Daejeon (KR)

(21) Appl. No.: 13/905,437

(22) Filed: May 30, 2013

(30) Foreign Application Priority Data
Oct. 26, 2012 (KR) 10-2012-0119988

(51) Int. Cl. H04N 13/00; H04N 5/232

(52) U.S. Cl. CPC H04N 13/0022; H04N 5/23238
USPC 348/36

(57) ABSTRACT

An apparatus for 2D to 3D conversion using a panorama image includes an image receiving unit for receiving and storing an input image, a user interface for receiving an input of a user who performs a 3D conversion work, a panorama image generating unit for extracting feature points of a plurality of images, a depth setting unit for recording scribbles including depth information in at least one of a plurality of pixels of the panorama image in response to the input of the user received through the user interface, a depth information propagating unit for calculating depth values of other pixels, a depth information remapping unit for mapping a depth value with respect to each of the plurality of images, and a stereo image generating unit for generating a stereo image pair for each of the plurality of images.

### CROSS-REFERENCE TO RELATED APPLICATION

This application claims priority of Korean Patent Application No. 10-2012-0119988, filed on Oct. 26, 2012, in the KIPO (Korean Intellectual Property Office), the disclosure of which is incorporated herein entirely by reference.

### BACKGROUND OF THE INVENTION

1. Field of the Invention

The present disclosure relates to a method and apparatus for 2D to 3D conversion, and more particularly, to a method and apparatus for 2D to 3D conversion using a panorama image.

2. Description of the Related Art

In these days, as the popularity of 3-dimensional (hereinafter, referred to as 3D) stereoscopic movies has increased, the number of contents made with 3D images has rapidly increased. However, in order to make a 3D image, two synchronized cameras are generally fixed to a stereo camera rig for photographing. However, making a 3D image using a stereo camera is not easy since various kinds of hardware such as cameras should be accurately corrected and post processes are demanded to ensure the level of difficulty for the control of the stereo camera rig and give convenience to spectators. As an alternative to solve the above problems, a technique of making a stereo image by converting a 2D image to a 3D image is being utilized. The 2D to 3D conversion is very useful since an existing 2D image may be converted into and reproduced as a 3D image.

The technique for converting a 2D image to a 3D image produces a stereo image pair corresponding to each of at least one single image. In order to generate a stereo image pair, a method of estimating suitable depth information of an image is well known in the art. If a depth map based on the depth information on an image is available, a stereo image pair may be generated by pixel translation of a single view sequence according to a depth value calculated at each location on the image. A method of estimating a depth of a monocular image or sequence based on a depth cue such as motion, fog or focus is currently being utilized and automated. However, this image is composed of a plurality of images frames, different from a single image, and depth maps respectively corresponding to the image frames should be organically connected with each other in a soft manner. Therefore, a 3D image obtained by an automated conversion method is inferior to the specialized high quality conversion demanded in the entertainment industry. Therefore, in order to make a 3D image with high quality, manual intervention for correcting a depth estimated by an automation method is utilized or an entire depth map is manually generated. However, this means that a very large amount of manual works should be performed.

Generally, in the case conversion quality should be ensured, a worker for 3D conversion should make manual inputs at every several frames or at every frame. In addition, for rotoscoping foreground objects, suitable depth painting is demanded in some cases. In addition, if consistency over time of an estimated depth map is demanded for the overall image sequence, the conversion work becomes more complex.

### SUMMARY OF THE INVENTION

An embodiment of the present disclosure is directed to providing a method for 2D to 3D conversion using a panorama image, in which a user records scribbles at a single panorama image corresponding to a plurality of image frames to generate depth information of an original image frame, thereby greatly reducing a workload of a 3D conversion worker.

The present disclosure is also directed to providing an apparatus for 2D to 3D conversion using a panorama image.

In one aspect of the present disclosure, there is provided an apparatus for 2D to 3D conversion using a panorama image, which includes: an image receiving unit for receiving and storing an input image; a user interface for receiving an input of a user who performs a 3D conversion work; a panorama image generating unit for extracting feature points of a plurality of images which compose an image sequence of the input image and warping and combining the plurality of images based on the extracted feature points to generate a single panorama image; a depth setting unit for recording scribbles including depth information in at least one of a plurality of pixels of the panorama image in response to the input of the user received through the user interface; a depth information propagating unit for calculating depth values of other pixels based on a depth value of the depth information of the at least one pixel in which the scribbles are recorded, to calculate depth values of all pixels of the panorama image and generate a panorama image depth map; a depth information remapping unit for mapping a depth value with respect to each of the plurality of images by using the depth map of the panorama image to generate an individual image depth map; and a stereo image generating unit for generating a stereo image pair for each of the plurality of images by using the individual image depth map and generating a stereo image by using the generated stereo image pair.

The panorama image generating unit may include a reference image selecting unit for selecting a reference image among the plurality of images according to a preset manner; a feature point tracking unit for extracting feature points from the plurality of images and tracking the feature points extracted from each of the plurality of images to be matched with feature points of the reference image; an image warping unit for warping images other than the reference image among the plurality of images according to the tracked feature points; and an image accumulating unit for accumulatively matching the plurality of warped images with the reference image based on the feature points to generate a single panorama image.

The panorama image generating unit may further include a confidence map generating unit for generating a confidence map by evaluating confidence of each of the plurality of pixels of the panorama image according to a preset manner.

The reference image selecting unit may select a single image among the plurality of images as the reference image in response to a command of the user applied through the user interface.

The apparatus may further include a color information analyzing unit for analyzing color information of each of the plurality of pixels of the panorama image and transmitting the color information to the depth information propagating unit.

The depth information propagating unit may calculate the depth values of all pixels of the panorama image by combining the depth information of the at least one pixel in which the scribbles are recorded, with the color information.

The depth information remapping unit may generate the individual image depth map by combining the depth map of the panorama image with the confidence map and thus performing a local image optimization work.

In another aspect of the present disclosure, there is also provided a method for 2D to 3D conversion using a panorama image, performed by an apparatus for 2D to 3D conversion which includes an image receiving unit, a user interface, a panorama image generating unit, a depth setting unit, a depth information propagating unit, a depth information remapping unit and a stereo image generating unit, the method including: by the image receiving unit, receiving and storing an input image; by the panorama image generating unit, extracting feature points of a plurality of images which compose an image sequence of the input image and warping and combining the plurality of images based on the extracted feature points to generate a single panorama image; by the depth setting unit, recording scribbles including depth information in at least one of a plurality of pixels of the panorama image in response to the input of the user received through the user interface; by the depth information propagating unit, calculating depth values of other pixels based on a depth value of the depth information of the at least one pixel in which the scribbles are recorded, to calculate depth values of all pixels of the panorama image and generate a panorama image depth map; by the depth information remapping unit, mapping a depth value with respect to each of the plurality of images by using the depth map of the panorama image to generate an individual image depth map; and by the stereo image generating unit, generating a stereo image pair for each of the plurality of images by using the individual image depth map and generating a stereo image by using the generated stereo image pair.

The generating of a panorama image may include selecting a reference image among the plurality of images according to a preset manner; extracting feature points from the plurality of images and tracking the feature points extracted from each of the plurality of images to be matched with feature points of the reference image; warping images other than the reference image among the plurality of images according to the tracked feature points; and accumulatively matching the plurality of warped images with the reference image based on the feature points.

The generating of a panorama image may further include generating a confidence map by evaluating confidence of each of the plurality of pixels of the panorama image according to a preset manner.

The selecting of a reference image may select a single image among the plurality of images as the reference image in response to a command of the user applied through the user interface.

The apparatus for 2D to 3D conversion may further include a color information analyzing unit, and the method for 2D to 3D conversion may further include analyzing color information of each of the plurality of pixels of the panorama image and transmitting the color information to the depth information propagating unit.

The generating of a panorama image depth map may calculate the depth values of all pixels of the panorama image by combining the depth information of the at least one pixel in which the scribbles are recorded, with the color information.

The generating of an individual image depth map may generate the individual image depth map by combining the depth map of the panorama image with the confidence map and thus performing a local image optimization work.

Therefore, the apparatus for 2D to 3D conversion using a panorama image according to the present disclosure converts an image composed of an image sequence into a single panorama image, designates depth information to the converted panorama image by means of scribbles of a worker, and then if the designated depth information is propagated to the entire panorama image to generate a depth map, remaps the depth map to the image sequence to generate a stereo image. Therefore, even though the worker performs manual works only to a single panorama image, a high quality 3D stereo image may be obtained. For this reason, it is possible to greatly reduce manual works of a 3D conversion worker and generate 3D stereo images which are organically connected in a soft manner according to time. In addition, since a perfect panorama image is not needed, the present disclosure may be easily applied to relatively free camera motions in comparison to the existing techniques.

### BRIEF DESCRIPTION OF THE DRAWINGS

The above and other features and advantages will become more apparent to those of ordinary skill in the art by describing in detail exemplary embodiments with reference to the attached drawings, in which:

FIG. 1 shows an apparatus for 2D to 3D conversion using a panorama image according to the present disclosure;

FIG. 2 shows a method for 2D to 3D conversion using a panorama image according to the present disclosure;

FIG. 3 shows an example to which a confidence map is applied;

FIG. 4 shows an example to which worker scribbles are applied;

FIG. 5 shows an example of a depth map calculated using color of a panorama image;

FIG. 6 comparatively shows mapping results before and after local image recognition optimization;

FIG. 7 shows an example of depth scaling;

FIG. 8 shows an example to which the method for 2D to 3D conversion using a panorama image as shown in FIG. 2 is applied;

FIG. 9 shows an experimental example of a 2D to 3D conversion process according to the movement of a camera;

FIG. 10 shows another example of the 2D to 3D conversion process according to the movement of a camera; and

FIG. 11 shows an example of an image converted into 3D according to the present disclosure.

In the following description, the same or similar elements are labeled with the same or similar reference numbers.

### DETAILED DESCRIPTION

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes”, “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. In addition, a term such as a “unit”, a “portion”, a “module”, a “block” or like, when used in the specification, represents a unit that processes at least one function or operation, and the unit or the like may be implemented by hardware or software or a combination of hardware and software.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Preferred embodiments will now be described more fully hereinafter with reference to the accompanying drawings. However, they may be embodied in different forms and should not be construed as limited to the embodiments set forth herein. Rather, these embodiments are provided so that this disclosure will be thorough and complete, and will fully convey the scope of the disclosure to those skilled in the art.

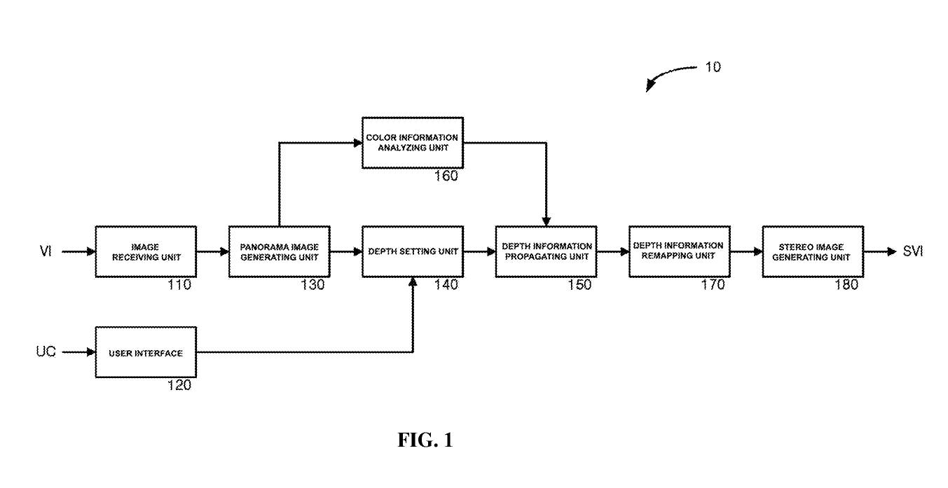

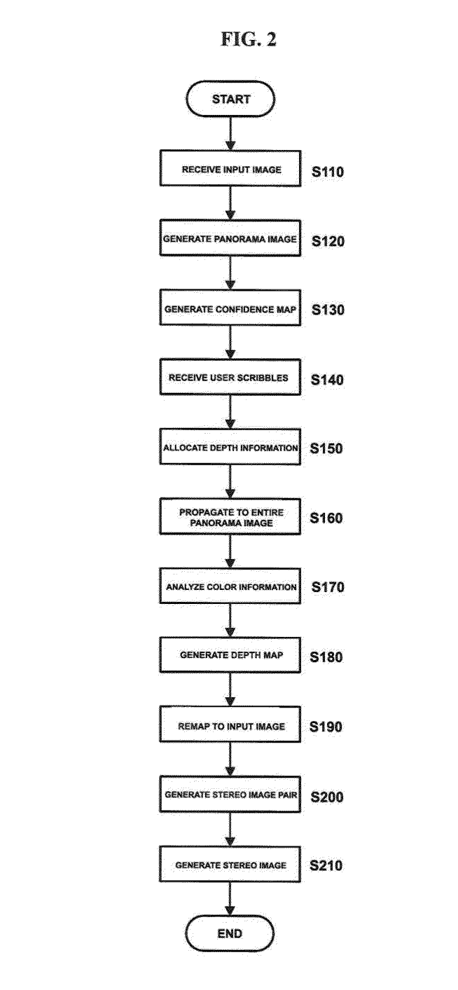

FIG. 1 shows an apparatus for 2D to 3D conversion using a panorama image according to the present disclosure, and FIG. 2 shows a method for 2D to 3D conversion using a panorama image according to the present disclosure.

Referring to FIG. 1, the apparatus 10 for 2D to 3D conversion according to the present disclosure includes an image receiving unit 110, a user interface 120, a panorama image generating unit 130, a depth setting unit 140, a depth information propagating unit 150, a color information analyzing unit 160, a depth information remapping unit 170 and a stereo image generating unit 180.

Referring to FIG. 2, a method for 2D to 3D conversion using the apparatus 10 for 2D to 3D conversion using a panorama image as shown in FIG. 1 will be described. First, the image receiving unit 110 receives and stores an input image (S110). The image receiving unit 110 may receive an input image in a wire/wireless manner from various external devices such as a PC, a network server, a database server and a cellular phone or from various recording media such as DVD or flash memory.

On occasions, a user may separately set a region of the stored input image, which is to be converted into a 3D image, through the user interface 120. In the present disclosure, the user may be interpreted as having the same meaning as a worker who converts a 2D image into a 3D image. However, on occasions, the user may be interpreted as being different from a conversion worker.

If the image receiving unit 110 receives and stores the input image, the panorama image generating unit 130 combines a plurality of images, which compose an image sequence of the input image, to generate a single panorama image (S120).

The technique of generating a single panorama image from a plurality of images is already well known in the art. For example, SZELISKI R., SHUM H.-Y. (Creating full view panoramic image mosaics and environment maps, In Proceedings of the 24th annual conference on Computer graphics and interactive techniques (New York, N.Y., USA, 1997), SIGGRAPH '97, ACM Press/Addison-Wesley Publishing Co., pp. 251??258. 2) and BROWN M., LOWE D. (Recognizing panoramas, In Computer Vision, 2003. Proceedings. Ninth IEEE International Conference on (October 2003), pp. 1218 ??1225 vol. 2. 2) disclose a method for calculating a homography matrix to generate a panorama image. However, the panorama image generating technique using a homography matrix is limitedly applied only to the case where the location of a camera is fixed.

Therefore, the present disclosure utilizes a warping technique in order to allow relatively free motion of the camera in comparison to the existing art. In the panorama image generating process of the present disclosure, first, a reference image is selected from the image sequence of the input image, and feature points are tracked with reference to the selected reference image so that unselected images are warped from an image adjacent to the reference image.

Any image in the image sequence composed of a plurality of images may be selected as the reference image. However, as an example, in the present disclosure, an image disposed at the center of the image sequence is selected as the reference image. However, the image sequence may also be designated directly by the user. In order to select the reference image and extract the feature points, the panorama image generating unit 130 may include a reference image selecting unit (not shown) for selecting a reference image from the image sequence according to a preset manner or a user command applied through a user interface, a feature point tracking unit (not shown) for tracking feature points on all images of the image sequence, an image warping unit (not shown) for warping images other than the reference image among the plurality of images according to the tracked feature points, and an image accumulating unit (not shown) for accumulatively matching the plurality of warped images with the reference image to generate a single panorama image.

If the reference image is selected by the reference image selecting unit, the feature points extracting unit tracks feature points over the entire image sequence. The feature points are tracked in order to guide each of a plurality of images to be combined with the reference image, when a panorama image is generated by combining the plurality of images with the reference image. By tracking the feature points, a tracking trajectory is calculated, and images in the image sequence other than the reference image are warped based on the calculated tracking trajectory.

By tracking the feature points, a feature point corresponding to the middle of an image (Iₜ) at a t^{th} frame (here, t is a natural number) and an image (Iₜ₊₁) at a t+1^{th} frame is identified. Assuming a location of a pixel on the image (Iₜ) is xₜ (here, xₜε [symbol] ²), a location of the warped pixel may be expressed as xₜ′ (here, xₜ′ε [symbol] ²). In order to determine the location (xₜ′) of the warped pixel by means of the characteristic harmonization technique, the present disclosure utilizes ‘Thin Plate Splines (hereinafter, TPS)’ as a kernel for Radial Basis Functions (RBF).

Equation 1 expresses TPS based on n feature points.

$$\begin{matrix}{x}_{t}^{′} = {\sum }_{i = 1}^{n} {w}_{i} φ ( {x}_{t} , {F}_{i} ) + A ( {x}_{t} ) \\ = [ \begin{matrix}{\sum }_{i = 1}^{n} {w}_{ix} φ ( {x}_{t} , {F}_{i} ) + {a}_{x 0} + {a}_{xx} x + {a}_{xy} y \\ {\sum }_{i = 1}^{n} {w}_{iy} φ ( {x}_{t} , {F}_{i} ) + {a}_{y 0} + {a}_{yx} x + {a}_{yy} y\end{matrix} ]\end{matrix} \qquad \underline{Equation 1}$$

Here, Fᵢ represents a location of a feature point in the reference image. This value is the center of RBF. wᵢε [symbol] ² represents a weight of RBF. φ(xₜ,Fᵢ) represents a kernel function, and ∥xₜ−Fᵢ∥ is used for minimizing bending energy. A (xₜ) represents an affine transformation of xₜ.

Equation 1 calculates a warped image (Iₜ) which is combinable with an existing panorama image. The final stage of the present disclosure described later is remapping depth values allocated to the panorama image as a background of the original image sequence. Therefore, the permutation vector Vₜ=xₜ−xₜ′ for encoding the original location should be preserved until 3D conversion is completed.

Warping results of the images are combined with the reference image in order. As long as the motion of the camera for photographing the input image is not limited just to rotation, the warped images are not exactly matched with the reference image. As a result, the combined image has an unclear area and a blurred area. Though such areas may be refined during the remapping process, in order to minimize unnecessary artifacts, only pixels newly marked with v are rendered to the reference image. This may generate a better image, which allows a depth to be allocated in the panorama image without any unnecessary artifact or blurred area.

The generated single panorama image includes contents of the input image since it is generated by combining the plurality of images of the input image.

The present disclosure does not demand a perfect panorama image. In other words, all images need not be exactly warped to the reference image. Since the panorama image may be imperfect, the present disclosure may allow relatively free motion of the camera which photographs the input image. However, the imperfect panorama image may have artifacts caused by motion parallax, occlusion, or feature tracking errors since the plurality of images are not regularly arranged. These artifacts may be mostly hidden by rendering the warped pixels in the generated panorama image. However, if a depth value is allocated to the corresponding location afterwards, an erroneous depth value may be mapped while being remapped to the original image sequence. This is an error in the conversion to a 3D stereo image, which should be avoided.

For this reason, the panorama image generating unit 130 includes a confidence estimating unit (not shown) to generate a confidence map by evaluating confidence of the generated panorama image (S130). The confidence map is an information map in which a confidence value for each location of the panorama image is displayed. In the panorama image, the confidence value (f_{c}(x′)) of a pixel (x) is obtained by means of color variance from the pixel location (x′) of each warped image. If the warped pixel (x′) corresponding to the pixel (x) in the panorama image has a similar color, the warped pixel (x′) has confidence.

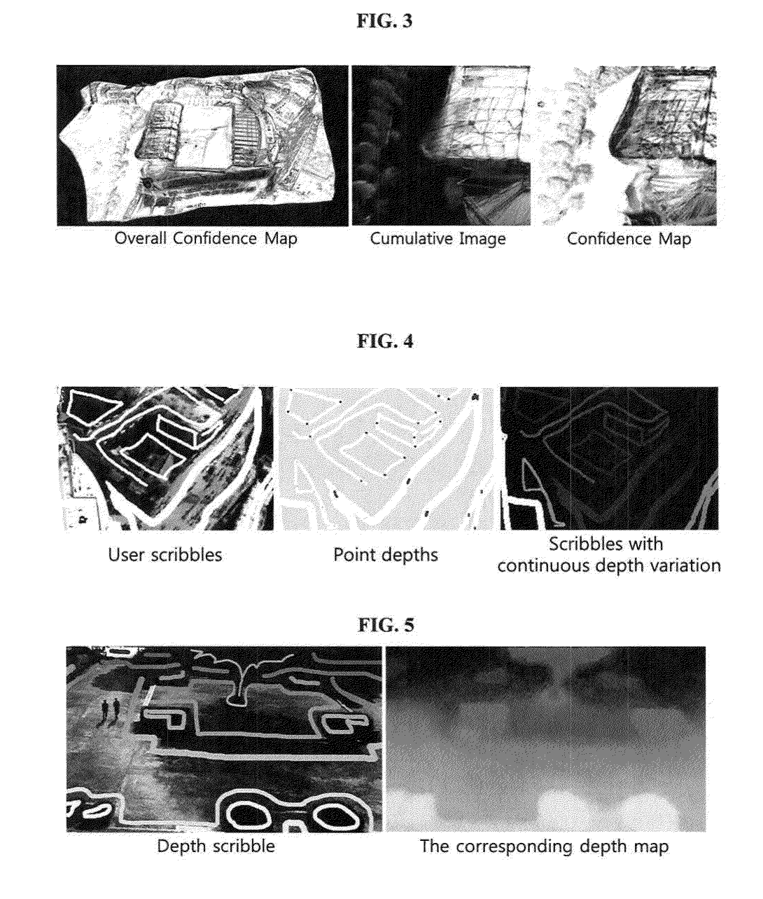

FIG. 3 shows an example to which the confidence map is applied.

In FIG. 3, a cumulative image represents an average color of warped pixels. According to the color variance (var(x′)) of all warped pixels at a specific location of the panorama image, the confidence value (f_{c}(x′)) is calculated according to Equation 2 below.

$${f}_{c} ( {x}^{′} ) = exp ( \frac{- var ( {x}^{′} )}{{σ}^{2}} ) \qquad \underline{Equation 2}$$

Here, σ is a user parameter for setting a level of contribution of color, when calculating the confidence value (f_{c}(x′)) by using color variance, and may be designated by the user to decide the level of confidence. In the present disclosure, σ is set to be 0.8, for example.

In order to calculate confidence of each pixel, a large amount of memory space is required. Therefore, the present disclosure uses an on-line algorithm, which is performed whenever the input for calculating variance of Equation 2 enters in order. The on-line algorithm may perform calculation with a small memory space since it does not receive all input data. Assuming that a new observation value of the color of the pixel (x) at t frame is cₜ, the observation value (cₜ) represents an average of all observation values obtained until now. Therefore, the on-line variance (varₜ) at the t frame may be updated like Equation 3 below.

$${\overline{c}}_{t} = {\overline{c}}_{t - 1} + \frac{{c}_{t} - {\overline{c}}_{t} - 1}{t} \\ {var}_{t} = \frac{( t - 1 ) {var}_{t - 1} + ( {c}_{t} - {\overline{c}}_{t} ) ( {c}_{t} - {\overline{c}}_{t - 1} )}{t} \qquad \underline{Equation 3}$$

In FIG. 3, the confidence map shows confidence measured for each pixel and represents a confidence value. In FIG. 3, a bright area shows relatively higher confidence in comparison to a dark area. In a low confidence area, the depth value is refined in a subsequent local image level. Low accumulative values account that they correspond to blurred areas. Areas adjacent to edges are displayed dark since they generally have low confidence levels. In FIG. 3, the entire confidence map in the left shows a confidence map for the entire panorama image in which a plurality of images are combined.

If the confidence map is generated, the depth setting unit 140 records scribbles, received from the user through the user interface 120, in the generated panorama image (S140). Here, the scribbles may be used for the user to designate a depth value at a specific location on the panorama image. The technique for providing user scribbles to designate an area of interest at an object in an image is already used in the image processing field as a dividing algorithm, an object extracting algorithm, a colorization algorithm or the like. For example, a method for a user to scribble a color at a specific location in order to convert an image of a gray scale into a color image is well known in the art. In the present disclosure, such scribbles are used for allowing the user to directly designate a depth in the panorama image. Here, the scribbles may designate a depth by using a size of the scribbles, a color of the scribbles or the like. In addition, in the case the user interface 120 is capable of sensing a touch pressure like a touch screen, the depth may be designated by using the touch pressure or any other manner.

Moreover, if the scribbles are recorded in the panorama image, depth information is allocated to the corresponding location by using the format of the scribbles or the information included in the scribbles (S150). Here, the depth information may be expressed as a depth value.

In the related art, scribbles have been generally used for pointing out an area of an image which possesses a certain object. However, in the present disclosure, scribbles are used for designating a depth. The depth tends to softly vary in a single object. In the related art, the process of converting a 2D image to a 3D image provides only a continuously varying stroke of a single level, in which a depth is not easily designated, like a depth of an object at a perspective view. However, in the present disclosure, the scribbles allow a depth to be designated at any location on the panorama image. Further, the user may easily allocate a depth even when scribbles are long, are closed or intersect each other.

The present disclosure applies the Laplace equation to depth and scribble pixels at the corresponding location by limiting the softly varying depth scribbles. Assuming that pixels in which scribbles are recorded is s, the Laplace-transformed pixel (s) is expressed like Equation 4 below.

Δs=M·s=0 Equation 4

Here, M represents an induced matrix of the Laplace equation.

FIG. 4 shows an example to which worker scribbles are applied. In FIG. 4, it is illustrated that depth and scribbles, estimated while softly varying, are generated from point depths provided by the user.

User interaction may be performed by repeatedly allocating scribbles and depths in turn. The scribbles may be used for controlling the propagation of the depth value in the overall panorama image. In the propagation, the depth value given by the user may spread to neighboring areas together with similar colors. In images, color edges may play a role of container.

If the depth information is allocated to a location at which the scribbles are recorded, the depth information propagating unit 150 estimates depths of other locations in which scribbles are not recorded, based on the location at which the depth information is allocated, so that the depth information is propagated to the entire area of the panorama image (S160). The technique of propagating the depth information is performed in the same way as an existing process of propagating color information to the entire image, and the depth information may be automatically propagated to the entire panorama image. In addition, the depth allocated at this time may be adjusted finely.

Depths may be propagated from the scribbles by discriminating depth values of the pixels of the entire panorama image.

In addition, the present disclosure has a simple assumption that pixels with similar colors have similar depths. Therefore, the color information analyzing unit 160 analyzes color information of each pixel of the panorama image and transmits the color information to the depth information propagating unit 150 (S160). When calculating a depth value, the depth information propagating unit 150 may calculate the depth value of each pixel by utilizing the color information together with the depth information according to the user scribbles. However, the color information may not be used when calculating a depth value. In other words, the color information analyzing unit 160 may be excluded.

If the depth values are discriminated, the depth information propagating unit 150 generates a depth map D for the entire panorama image (S170).

Equation 5 is an equation for discriminating depth values of pixels (x) in the depth map D.

$${arg min}_{D} {\sum }_{x ∉ U}^{ } {‖ D ( x ) - {\sum }_{s ∈ N ( x )}^{ } {w}_{s} D ( s ) ‖}^{2} + {\sum }_{x ∈ U}^{ } {‖ D ( x ) - U ( x ) ‖}^{2} \qquad \underline{Equation 5}$$

Here, U represents scribble pixels, N(x) represents a group of pixels adjacent to the pixel x, and wₛ is a weighted affinity function whose sum is 1. The weighted affinity function is expressed like Equation 6 below.

$${w}_{s} ∝ {e}^{- {( C ( x ) - C ( s ) )}^{2} / 2 {σ}_{s}^{2}} \cdot {\sum }_{s ∈ N ( x )}^{ } {w}_{s} = 1 \qquad \underline{Equation 6}$$

Here, C(x) and C(s) represent color vectors of the pixel (x) and the Laplace-transformed pixel (s), respectively. A CIELab color space is used to calculate an affinity function. The 3×3 window centered in the pixel (x) determines neighboring pixels.

FIG. 5 shows an example of a depth map calculated by using the color of the panorama image.

If the depth map is generated, a depth map generated afterwards is respectively remapped to the original images of the image sequence (S190). However, in the present disclosure, the depth map is not simply remapped to the original images but is remapped to the original images by means of local image optimization while considering the confidence value (f_{c}(x)) together.

By using the displacement vector field (Vₜ), both the initial depth value (Dᵢ(x)) and the confidence value (f_{c}(x)) may be discriminated at the image (Iₜ) with respect to each pixel (x). Similar to Equation 4, the local image optimization discriminates confidence values and depth value Dₜ(x) recalculated according to consistency over time. The present disclosure configures a refinement energy function with three items as in Equation 7 for minimization.

E=Eᵢ=Eₛ+Eₜ Equation 7

Here, Eᵢ represents a difference between the initial depth value (Dᵢ(x)) and the recalculated depth value (Dₜ(x)), Eₛ represents softness of the depth map, and Eₜ represents variation of the depth from the previous frame. Eᵢ is calculated by Equation 8 below.

$${E}_{i} = {\sum }_{x}^{ } {f}_{c} ( x ) {‖ {D}_{i} ( x ) - {D}_{i} ( x ) ‖}^{2} \qquad \underline{Equation 8}$$

As defined in Equation 5, color variation of pixels adjacent to the pixel (x) is calculated by means of the weighted affinity function (wₛ). Similar colors may contribute more to the discrimination of depth.

$${E}_{s} = {\sum }_{x}^{ } ( 1 - τ ) ( 1 - {f}_{c} ( x ) ) {‖ {D}_{t} ( x ) - {\sum }_{s ∈ N ( x )}^{ } {w}_{s} {D}_{s} ( x ) ‖}^{2} \qquad \underline{Equation 9}$$

Here, τ represents an energy weight over time. The depth value (Dₛ(x)) is a depth value of a pixel adjacent to the pixel (x). Eₛ becomes important if the confidence values and the energy weight over time (τ) are lowered.

$${E}_{t} = {\sum }_{x}^{ } τ ( 1 - {f}_{c} ( x ) ) {‖ {D}_{t} ( x ) - {D}_{t - 1} ( {x}_{n} ) ‖}^{2} \qquad \underline{Equation 10}$$

Here, Dₜ₋₁(xₙ) represents a depth value of a pixel (xₙ) adjacent to the pixel (x) at the frame t−1.

Assuming that the movement of the pixel at the frame t is ν, if Equation 11 is satisfied, the pixel (xₙ) is a pixel adjacent to the pixel (x) at the time t−1.

∥(x+ν(x))−xₙ∥≦δ Equation 11

Here, δ is a threshold value.

At each pixel (x), space and time derivatives (dₓ,d_{y},dₜ) are calculated. νₓ=dₓ/dₜ and ν_{y}=d_{y}/dₜ respectively capture horizontal and vertical movements. This approximation efficiently substitutes the optical flow calculation which consumes more expense.

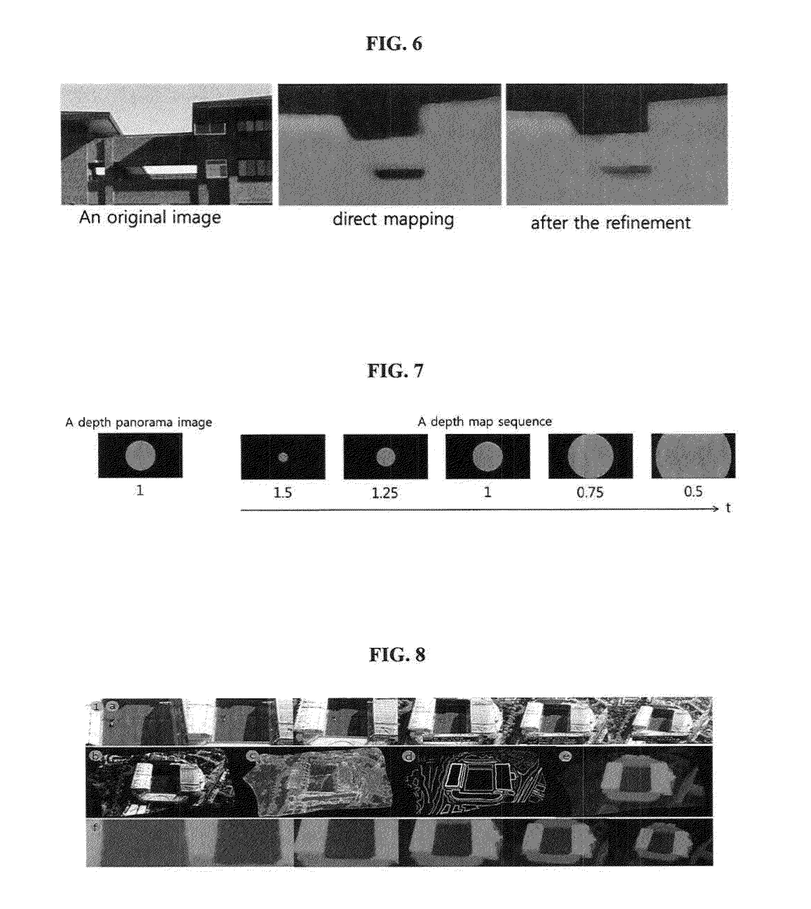

FIG. 6 comparatively shows a mapping result after the local image recognition optimization and a direct mapping result, side by side. It may be found that in the local optimization, the most blurred region is expressed sharp by using the difference in color between a building and the sky.

In addition, the recalculated depth map is additionally corrected. Since depth values are inferred from a single panorama depth map, each remapped map has the identical depth value range. These values should be adjusted to reflect motion or zoom of cameras.

FIG. 7 shows an example of depth scaling. In the depth panorama image, the depth value is assumed as 1. In this case, the depth value of an object shown in all of the plurality of images of the image sequence should gradually decrease as shown in FIG. 7 if the object is gradually enlarged.

The final depth map (Dₜ^{f}) is obtained by Equation 12 below.

dₜ^{f}=sₜ*Dₜ Equation 12

Here, sₜ is an overtime of the variation depth scaling. If a camera makes a simple motion such as panning or tilting, the depth scaling function may not be designated. However, in the image sequence, if the camera makes a simpler motion such as zooming, a simple linear function will be sufficient. In the present disclosure, the scaling function is automatically calculated by considering a ratio of a characteristic size according to the reference frame. Additionally, the present disclosure allows a user to control the scaling function by means of a curve editor.

After the remapping is performed, the stereo image generating unit 180 may generate a stereo image pair in real time by using the scaling result (S200). In addition, by using the generated stereo image pair, the stereo image generating unit 180 generates a stereo image (S210). The scaling function may give an additional control to the final disparities.

In addition, if the camera may be corrected from the tracking step, the scaling may be automatically estimated from the camera parameter. Assuming that a distance from the camera to the intersection pint is |Zₜ| and a distance from the reference camera to the intersection point is |Z_{ref}| in consideration of the intersection points of view vectors of the camera and the reference camera at the t^{th} frame, the ratio of both distances is determined as ΔZ=|Zₜ|/|Z_{ref}|. Accordingly, the final depth map is obtained by Equation 13 below.

Dₜ^{f}=ΔZ*Dₜ Equation 13

FIG. 8 shows an example to which the method for 2D to 3D conversion using a panorama image as shown in FIG. 2 is applied.

FIG. 8 shows an image of each step according to the method for 2D to 3D conversion using a panorama image according to the present disclosure.

The input image (a) is matched with the reference image and continuously transformed, and all transformed images are combined to generate a panorama image (b) as a result. The user allocates depth information by recording scribbles in the panorama image (c). The scribbles of the user are propagated to the panorama image (d) afterwards as depth information. Finally, the high-density depth information is remapped as a plurality of images of the original input image sequence (e) by means of the image recognition refinement process.

The image sequence of FIG. 8 is obtained from a moving airplane. In addition, the motion of the camera is a combination of translation and rotation.

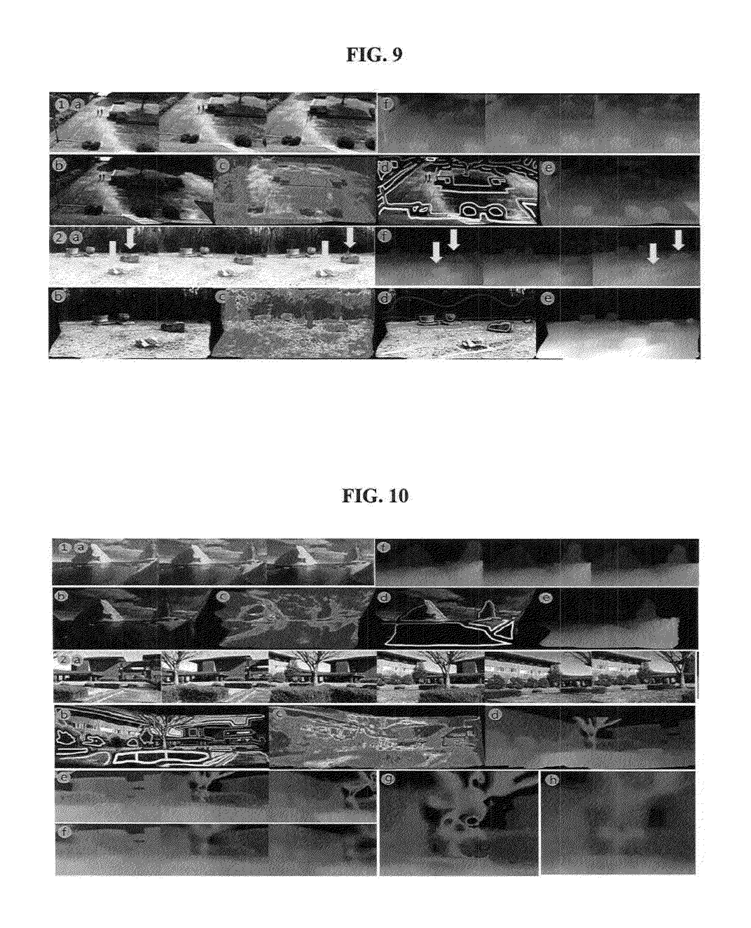

FIG. 9 shows an experimental example of a 2D to 3D conversion process according to the motion of a camera. In FIG. 9, the method of the present disclosure is experimented on the image sequences with different camera motions.

In FIG. 9, diagrams 1a to 1e show a transformation process of an image when the camera makes only a rotating motion, and diagrams 2a to 2e show a transformation process of an image when the camera makes a translation. In the diagrams 1 and 2, a represents an input image sequence, b represents a panorama image, c represents a confidence map, d represents depth scribbles by the user, e resultantly represents a depth map, and f represents an output depth map sequence, respectively. In the confidence map c, the blue area corresponds to high confidence values, and the red area corresponds to low confidence values.

In FIG. 9, the image sequence is photographed by means of a purely rotating camera which allows the generation of a ceaseless panorama. Diagram 1-b of FIG. 9 represents a visually ceaseless perfect panorama image. The corresponding confidence map (1-c) shows a relatively high confidence value expressed by the blue color. The quality of the panorama image shows the individual depth map (1-f) which is sufficiently restored.

In FIG. 9, the diagram 2 shows a sequence according to just a translation of the camera. In the diagram 2-a, the camera moves right. Two stones disposed at the front of the camera (designated by the yellow arrow) show a motion parallax characteristic due to translation of the camera. A distance between both stones increases at the end of the sequence, even though a distance between other two stones does not change seriously in the background. The above homography-based technique is not capable of processing a video pattern according to such a clear motion parallax. Contrastively, the feature-based warping technique of the present disclosure may reasonably align such an image sequence. The image may be distorted in order to match four stones in the image. However, some alignment errors are marked in red on the confidence map in the diagram 2-c. The red arrow designates two stones which have a great motion parallax. Their confidence values are low as expected. However, the low confidence area is recalculated in the remapping step. As a result, the output depth map sequence has consistency over time, and in the depth map sequence, two stones may sufficiently reduce the motion parallax.

FIG. 10 shows another example of the 2D to 3D conversion process according to the motion of a camera.

The image sequence of the diagram 1 of FIG. 10 is photographed from a ship and includes both camera rotation and translation. The ship moves at the rear, and the camera rotates to capture the entire iceberg. Each image frame includes other sides of the iceberg. A complex camera motion causes motion parallax and occlusion. In the diagram 1-d of FIG. 10, due to relatively simple user scribbles and suitable depth allocation, the present disclosure smoothly generates a variable depth map in each frame of the diagram 1-f.

In FIG. 10, the image sequence of the diagram 2 is photographed by using a portable camera. This includes translation, rotation, noisy motion and occlusion from a tree.

In the diagram 2 of FIG. 10, a represents an input image sequence, b represents a panorama image and depth scribbles by the user, c represents a confidence map, d represents a resultant depth map, e represents an output depth map sequence according to direct mapping, f represents an output depth map sequence after the image recognition refinement, g represents an enlarged example of the direct mapping, and h represents an enlarged example of the image recognition refinement.

Confidence values around the tree are very low due to occlusion. The occlusion disturbs accurate estimation between successive frames. If the direct mapping is applied as shown in the diagram g, the remapped depth map sequence experiences serious distortion and artifacts. The local image recognition optimization improves the result to some extend as shown in the diagram h. The depth sequence result may need more improvement but is still useful as a rough depth map.

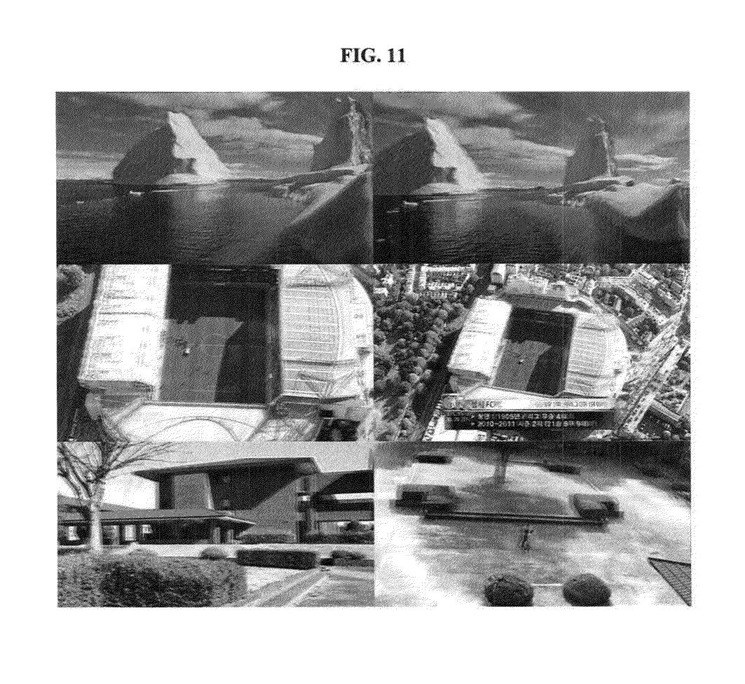

FIG. 11 shows an example of an image converted into 3D according to the present disclosure.

The output depth map sequence may be used for converting the input image sequence to a 3D stereo image sequence. FIG. 11 shows stereo photos of tested shots. For this purpose, a modification of the stereo optimization warping was used. Since a hole-filling process is not necessary by warping a source image to generate a stereo pair, visual artifacts are reduced.

The method according to the present disclosure may be implemented as computer-readable codes on a computer-readable recording medium. The computer-readable recording medium includes all kinds of recording devices which store data readable by a computer system. The recording medium is, for example, ROM, RAM, CD-ROM, magnetic tapes, floppy disks, optical data storages or the like, and may also be implemented in the form of carrier wave (for example, to be transmittable through Internet). In addition, the computer-readable recording medium may be distributed to computer systems connected through a network so that the computer-readable codes are stored and executed in a distribution way.

While the present disclosure has been described with reference to the embodiments illustrated in the figures, the embodiments are merely examples, and it will be understood by those skilled in the art that various changes in form and other embodiments equivalent thereto can be performed. Therefore, the technical scope of the disclosure is defined by the technical idea of the appended claims.

The drawings and the forgoing description gave examples of the present invention. The scope of the present invention, however, is by no means limited by these specific examples. Numerous variations, whether explicitly given in the specification or not, such as differences in structure, dimension, and use of material, are possible. The scope of the invention is at least as broad as given by the following claims.

What is claimed is:

1. An apparatus for 2D to 3D conversion using a panorama image, the apparatus comprising:
an image receiving unit receiving and storing an input image;
a user interface receiving an input of a user who performs a 3D conversion work;
a panorama image generating unit extracting feature points of a plurality of images which compose an image sequence of the input image and warping and combining the plurality of images based on the extracted feature points to generate a single panorama image;
a depth setting unit recording scribbles including depth information in at least one of a plurality of pixels of the panorama image in response to the input of the user received through the user interface;
a depth information propagating unit calculating depth values of other pixels based on a depth value of the depth information of the at least one pixel in which the scribbles are recorded, to calculate depth values of all pixels of the panorama image and generate a panorama image depth map;
a depth information remapping unit mapping a depth value with respect to each of the plurality of images by using the depth map of the panorama image to generate an individual image depth map; and
a stereo image generating unit generating a stereo image pair for each of the plurality of images by using the individual image depth map and generating a stereo image by using the generated stereo image pair.

2. The apparatus for 2D to 3D conversion using a panorama image of claim 1, wherein the panorama image generating unit includes:
a reference image selecting unit selecting a reference image among the plurality of images according to a preset manner;
a feature point tracking unit extracting feature points from the plurality of images and tracking the feature points extracted from each of the plurality of images to be matched with feature points of the reference image;
an image warping unit warping images other than the reference image among the plurality of images according to the tracked feature points; and
an image accumulating unit accumulatively matching the plurality of warped images with the reference image based on the feature points to generate a single panorama image.

3. The apparatus for 2D to 3D conversion using a panorama image of claim 2, wherein the panorama image generating unit further includes:
a confidence map generating unit for generating a confidence map by evaluating confidence of each of the plurality of pixels of the panorama image according to a preset manner.

4. The apparatus for 2D to 3D conversion using a panorama image of claim 3, wherein the reference image selecting unit selects a single image among the plurality of images as the reference image in response to a command of the user applied through the user interface.

5. The apparatus for 2D to 3D conversion using a panorama image of claim 3, further comprising:
a color information analyzing unit for analyzing color information of each of the plurality of pixels of the panorama image and transmitting the color information to the depth information propagating unit.

6. The apparatus for 2D to 3D conversion using a panorama image of claim 5, wherein the depth information propagating unit calculates the depth values of all pixels of the panorama image by combining the depth information of the at least one pixel in which the scribbles are recorded, with the color information.

7. The apparatus for 2D to 3D conversion using a panorama image of claim 6, wherein the depth information remapping unit generates the individual image depth map by combining the depth map of the panorama image with the confidence map and thus performing a local image optimization work.

8. The apparatus for 2D to 3D conversion using a panorama image of claim 2, wherein the reference image selecting unit selects a single image among the plurality of images as the reference image in response to a command of the user applied through the user interface.

9. The apparatus for 2D to 3D conversion using a panorama image of claim 1, further comprising:
a color information analyzing unit for analyzing color information of each of the plurality of pixels of the panorama image and transmitting the color information to the depth information propagating unit.

10. The apparatus for 2D to 3D conversion using a panorama image of claim 2, further comprising:
a color information analyzing unit for analyzing color information of each of the plurality of pixels of the panorama image and transmitting the color information to the depth information propagating unit.

11. A method for 2D to 3D conversion using a panorama image, performed by an apparatus for 2D to 3D conversion which includes an image receiving unit, a user interface, a panorama image generating unit, a depth setting unit, a depth information propagating unit, a depth information remapping unit and a stereo image generating unit, the method comprising:
receiving and storing an input image by the image receiving unit;
extracting feature points of a plurality of images which compose an image sequence of the input image and warping and combining the plurality of images based on the extracted feature points to generate a single panorama image by the panorama image generating unit;
recording scribbles including depth information in at least one of a plurality of pixels of the panorama image in response to the input of the user received through the user interface by the depth setting unit;
calculating depth values of other pixels based on a depth value of the depth information of the at least one pixel in which the scribbles are recorded, to calculate depth values of all pixels of the panorama image and generate a panorama image depth map by the depth information propagating unit;
mapping a depth value with respect to each of the plurality of images by using the depth map of the panorama image to generate an individual image depth map by the depth information remapping unit; and
generating a stereo image pair for each of the plurality of images by using the individual image depth map and generating a stereo image by using the generated stereo image pair by the stereo image generating unit.

12. The method for 2D to 3D conversion using a panorama image of claim 11, wherein the generating of a panorama image includes:
selecting a reference image among the plurality of images according to a preset manner;
extracting feature points from the plurality of images and tracking the feature points extracted from each of the plurality of images to be matched with feature points of the reference image;
warping images other than the reference image among the plurality of images according to the tracked feature points; and
accumulatively matching the plurality of warped images with the reference image based on the feature points.

13. The method for 2D to 3D conversion using a panorama image of claim 12, wherein the generating of a panorama image further includes:
generating a confidence map by evaluating confidence of each of the plurality of pixels of the panorama image according to a preset manner.

14. The method for 2D to 3D conversion using a panorama image of claim 13, wherein the selecting of a reference image selects a single image among the plurality of images as the reference image in response to a command of the user applied through the user interface.

15. The method for 2D to 3D conversion using a panorama image of claim 13,
wherein the apparatus for 2D to 3D conversion further includes a color information analyzing unit, and
wherein the method for 2D to 3D conversion further comprises analyzing color information of each of the plurality of pixels of the panorama image and transmitting the color information to the depth information propagating unit.

16. The method for 2D to 3D conversion using a panorama image of claim 15, wherein the generating of a panorama image depth map calculates the depth values of all pixels of the panorama image by combining the depth information of the at least one pixel in which the scribbles are recorded, with the color information.

17. The method for 2D to 3D conversion using a panorama image of claim 16, wherein the generating of an individual image depth map generates the individual image depth map by combining the depth map of the panorama image with the confidence map and thus performing a local image optimization work.

18. The method for 2D to 3D conversion using a panorama image of claim 12, wherein the selecting of a reference image selects a single image among the plurality of images as the reference image in response to a command of the user applied through the user interface.

19. The method for 2D to 3D conversion using a panorama image of claim 11, further comprising:
analyzing color information of each of the plurality of pixels of the panorama image and transmitting the color information to the depth information propagating unit.

20. The method for 2D to 3D conversion using a panorama image of claim 12,
analyzing color information of each of the plurality of pixels of the panorama image and transmitting the color information to the depth information propagating unit.
